(19) United States
(12) Patent Application Publication
(10) Pub. No.: US 2009/0319896 A1
(43) Pub. Date: Dec. 24, 2009

(54) VISUAL INDICATORS ASSOCIATED WITH A MEDIA PRESENTATION SYSTEM

(75) Inventors: David P. Green, Castaic, CA (US); Eric J. Bennett, Los Angeles, CA (US); Tommi J. Iten, Redondo Beach, CA (US); Tyson L. Wintibaugh, Marina del Rey, CA (US)

Correspondence Address: THE DIRECTV GROUP, INC.;PATENT DOCKET ADMINISTRATION, CA / LA1 / A109, 2230 E. IMPERIAL HIGHWAY, EL SEGUNDO, CA, 90245, US

(73) Assignee: THE DIRECTV GROUP, INC., El Segundo, CA (US)

(21) Appl. No.: 12/132,160

(22) Filed: Jun. 3, 2008

(51) Int. Cl. G06F 3/01

(52) U.S. Cl. 715/708

(57) ABSTRACT

Visual indicators associated with a media presentation system are described. An example apparatus includes a media presentation system in which one or more events may occur; an event controller to detect an event that causes the media presentation system to generate a sound to inform a user of a condition and to determine if the user is able to audibly receive the sound; and a visual indicator corresponding to the condition to be displayed in response to a determination that the user is unable to audibly receive the sound.

### FIELD OF THE DISCLOSURE

The present disclosure relates generally to media presentation systems and, more particularly, to visual indicators associated with a media presentation system.

### BACKGROUND

Media presentation systems often include a user interface to assist a user in utilizing the various services (e.g., an on-demand service) and/or content (e.g., television programming or music channels) of a media delivery system (e.g., a cable or satellite delivery system). Such a user interface may be implemented via on-screen graphics (e.g., menus, lists, etc.) that may be sorted through or manipulated. During utilization of the user interface or the media presentation system in general, the user may engage a button or select an option that causes the system to inform the user that an action cannot be taken or that the requested action was successfully performed. This may cause the media presentation system to produce a sound warning the user that the action was performed, cannot be performed, or is unavailable when the system or user interface is in a certain condition or state. For example, when the end of a menu is reached and a cursor can no longer be scrolled, the media presentation system may produce an audible ‘bonk’ or ‘beep,’ thereby alerting the user that the desired action is unavailable.

### BRIEF DESCRIPTION OF THE DRAWINGS

FIG. 1 is a diagram of an example direct-to-home (DTH) transmission and reception system.

FIG. 2 illustrates an example manner of implementing the example integrated receiver/decoder (IRD) of FIG. 1.

FIG. 3 is a flowchart representing an example process that may be performed by a media presentation system implementing an example visualization feature.

FIG. 4 shows an example screenshot including an example visual indicator.

FIG. 5 shows an example screenshot including another example visual indicator.

FIG. 6 shows an example screenshot including another example visual indicator.

FIG. 7 shows an example screenshot including another example visual indicator.

FIG. 8 illustrates an example manner of implementing an example processor unit to execute the example methods and apparatus described herein.

### DETAILED DESCRIPTION

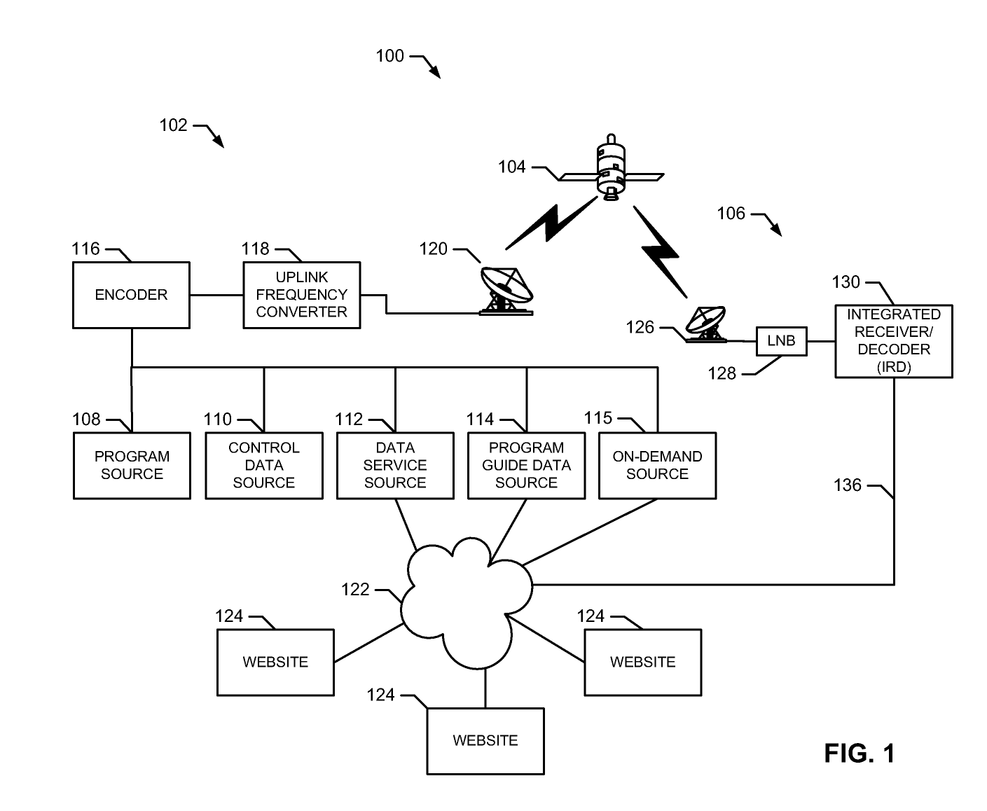

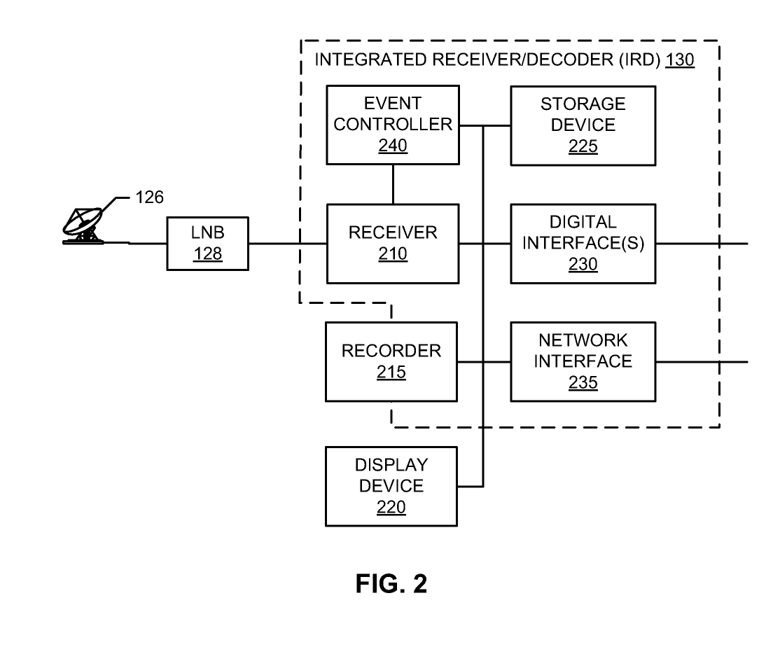

The example methods and apparatus to display visual indicators associated with a media presentation system (e.g., a home entertainment system including a media signal decoder and a television) described herein may be implemented in connection with any type of media broadcasting system including, for example, satellite broadcast systems, cable broadcast systems, radio frequency wave broadcast systems, etc. By way of illustration, an example broadcast system is described below in connection with FIG. 1 and an example receiver (e.g., set-top-boxes, broadcast signal decoders, etc.) is described in detail below in connection with FIG. 2. Further, while the following disclosure is made with respect to example DIRECTV® services and systems, it should be understood that many other delivery systems are readily applicable to the described methods and apparatus. Such systems include wired or cable distribution systems, Ultra High Frequency (UHF)/Very High Frequency (VHF) radio frequency systems or other terrestrial broadcast systems (e.g., Multi-channel Multi-point Distribution System (MMDS), Local Multi-point Distribution System (LMDS), etc.), and/or fiber optic networks.

As illustrated in FIG. 1, an example direct-to-home (DTH) system 100 generally includes a transmission station 102, a satellite/relay 104 and a plurality of receiver stations, one of which is shown at reference numeral 106, between which wireless communications are exchanged. The wireless communications may take place at any suitable frequency, such as, for example, Ku-band frequencies. As described in detail below with respect to each portion of the system 100, information from the transmission station 102 is transmitted to the satellite/relay 104, which may be at least one geosynchronous or geo-stationary satellite that, in turn, rebroadcasts the information over broad geographical areas on the earth that include receiver stations 106. To facilitate backchannel communications, the receiver stations 106 may be communicatively coupled to the transmission station 102 via a terrestrial communication link, such as a telephone line and/or an Internet connection 136.

In further detail, the example transmission station 102 of the example system of FIG. 1 includes a plurality of sources of data and/or information (e.g., program sources 108, a control data source 110, a data service source 112, one or more program guide data sources 114, and an on-demand source 115). During operation, information from one or more of these sources 108-115 passes to an encoder 116, which encodes the information for broadcast to the satellite/relay 104. Encoding includes, for example, converting the information into data streams that are multiplexed into a packetized data stream or bitstream using any of a variety of algorithms. A header is attached to each data packet within the packetized data stream to facilitate identification of the contents of the data packet. The header also includes a service channel identifier (SCID) that identifies the data packet. This data packet is then encrypted. As will be readily appreciated by those having ordinary skill in the art, a SCID is one particular example of a program identifier (PID).

To facilitate the broadcast of information, the encoded information passes from the encoder 116 to an uplink frequency converter 118 that modulates a carrier wave with the encoded information and passes the modulated carrier wave to an uplink antenna 120, which broadcasts the information to the satellite/relay 104. Using any of a variety of techniques, the encoded bitstream is modulated and sent through the uplink frequency converter 118, which converts the modulated encoded bitstream to a frequency band suitable for reception by the satellite/relay 104. The modulated, encoded bitstream is then routed from the uplink frequency converter 118 to the uplink antenna 120 where it is broadcast toward the satellite/relay 104.

The programming sources 108 receive video and audio programming from a number of sources, including satellites, terrestrial fiber optics, cable, or tape. The video and audio programming may include, but is not limited to, television programming, movies, sporting events, news, music or any other desirable content.

Like the programming sources 108, the control data source 110 passes control data to the encoder 116. Control data may include data representative of a list of SCIDs to be used during the encoding process, or any other suitable information.

The data service source 112 receives data service information and web pages made up of text files, graphics, audio, video, software, etc. Such information may be provided via a network 122. In practice, the network 122 may be the Internet, a local area network (LAN), a wide area network (WAN) or a conventional public switched telephone network (PSTN). The information received from various sources is compiled by the data service source 112 and provided to the encoder 116. For example, the data service source 112 may request and receive information from one or more websites 124. The information from the websites 124 may be related to the program information provided to the encoder 116 by the program sources 108, thereby providing additional data related to programming content that may be displayed to a user at the receiver station 106.

The program guide data source 114 compiles information related to the SCIDs used by the encoder 116 to encode the data that is broadcast. For example, the program guide data source 114 includes information that the receiver stations 106 use to generate and display a program guide to a user, wherein the program guide may be a grid guide that informs the user of particular programs that are available on particular channels at particular times. The program guide also includes information that the receiver stations 106 use to assemble programming for display to the user. For example, if the user desires to watch a baseball game on his or her receiver station 106, the user will tune to a channel on which the game is offered. The receiver station 106 gathers the SCIDs related to the game, wherein the program guide data source 114 has previously provided to the receiver station 106 a list of SCIDs that correspond to the game. Such a program guide may be manipulated via an input device (e.g., a remote control). For example, a cursor may be moved to highlight a program description within the guide. A user may then select a highlighted program description via the input device to navigate to associated content (e.g., an information screen containing a summary of a television show episode) or active an interactive feature (e.g., a program information screen, a recording process, a future showing list, etc.) associated with an entry of the program guide.

The on-demand (OD) source 115 receives data from a plurality of sources, including, for example, television broadcasting networks, cable networks, system administrators (e.g., providers of the DTH system 100), or other content distributors. Such content may include television programs, sporting events, movies, music, and corresponding information (e.g., user interface information for OD content) for each program or event. The content may be stored (e.g., on a server) at the transmission station 102 or locally (e.g., at a receiver station 106), and may be updated to include, for example, new episodes of television programs, recently released movies, and/or current advertisements for such content. Via a user interface, which also may be updated periodically, a user (e.g., a person with a subscription to an OD service) may request (i.e., demand) programming from the OD source 115. The system 100 may then stream the requested content to the user (e.g., over the satellite/relay 104 or the network 122) or make it available for download and storage (discussed further below in connection with FIG. 2). Thus, an OD service allows a user to view, download, and/or record selected programming at any time.

The satellite/relay 104 receives the modulated, encoded Ku-band bitstream and re-broadcasts it downward toward an area on earth that includes the receiver station 106. In the illustrated example of FIG. 1, the example receiver station 106 includes a reception antenna 126 connected to a low-noise-block (LNB) 128 that is further connected to an integrated receiver/decoder (IRD) 130. The IRD 130 may be a set-top box, a personal computer (PC) having a receiver card installed therein, or any other suitable device.

The receiver station 106 may also incorporate a connection 136 (e.g., Ethernet circuit or modem for communicating over the Internet) to the network 122 for transmitting requests and other data back to the transmission station 102 (or a device managing the transmission station 102 and overall flow of data in the example system 100) and for communicating with websites 124 to obtain information therefrom.

In operation of the receiver station 106, the reception antenna 126 receives signals including a bitstream from the satellite/relay 104. The signals are coupled from the reception antenna 126 to the LNB 128, which amplifies and, optionally, downconverts the received signals. The LNB output is then provided to the IRD 130.

FIG. 2 illustrates one example manner of implementing the IRD 130 (e.g., a set-top box) of FIG. 1. The IRD 130 of FIG. 2 is merely an example and other IRD implementations are possible. The LNB output is provided to a receiver 210, which receives, demodulates, de-packetizes, de-multiplexes, decrypts and/or decodes the received signal to provide audio and video signals to a display device 220 (e.g., a television set or computer monitor) and/or a recorder 215. The receiver 210 is responsive to user inputs to, for example, tune to a particular program.

As illustrated in FIG. 2, the recorder 215 may be implemented separately from and/or within the IRD 130. The recorder 215 may be, for example, a device capable of recording information on a storage device 225, for instance, analog media such as videotape, or computer readable digital media such as a hard disk drive, a digital versatile disc (DVD), a compact disc (CD), flash memory, and/or any other suitable media. The storage device 225 is used to store the packetized assets and/or programs received via the satellite/relay 104 (e.g., a movie requested from the OD source 115). In particular, the packets stored on the storage device 225 are the same encoded and, optionally, encrypted packets created by the transmission station 102 and transmitted via the satellite/relay 104.

To communicate with any of a variety of clients, media players, etc., the example IRD 130 includes one or more digital interfaces 230 (e.g., USB, serial port, Firewire, etc.). To communicatively couple the example IRD 130 to, for instance, the Internet and/or a home network, the example IRD 130 includes a network interface 235 that implements, for example, an Ethernet interface.

Further, the example IRD 130 includes an example event controller 240 to monitor and/or respond to events occurring in, for example, a user interface (e.g., a plurality of interacting on-screen menus, lists, queues, etc. to be manipulated via a remote control) or the system 100 in general. Specifically, the example event controller 240 monitors events associated with an aspect of the media presentation system (e.g., features of the user interface), determines what response or what type of response the events invoke, and, in some examples, causes the media presentation system to audibly and/or visually inform a user of a condition (e.g., successful action taken or action unavailable) or a state of an element (e.g., the user interface) of the media presentation system. Events may be internal (e.g., requests to store a program in memory that may or may not have sufficient free space) or external (e.g., failed transfers of data between the transmission station 102 and the receiver station 106) of the IRD 130 and may include a selection of a feature or option (e.g., a scheduling of a recording, scrolling through a menu, selecting a channel for tuning, etc.), activation or deactivation of the user interface, changing of modes, a request for information, a systematic error, a completion of a download, a system confirmation or notification, etc. Further, the characteristics, aspects, or general operation of the responses (e.g., visual indicators) to the events, as generated by the event controller 240, may be dependent on an operational state or settings of the IRD 130, the display device 220, or other component of the media presentation system.

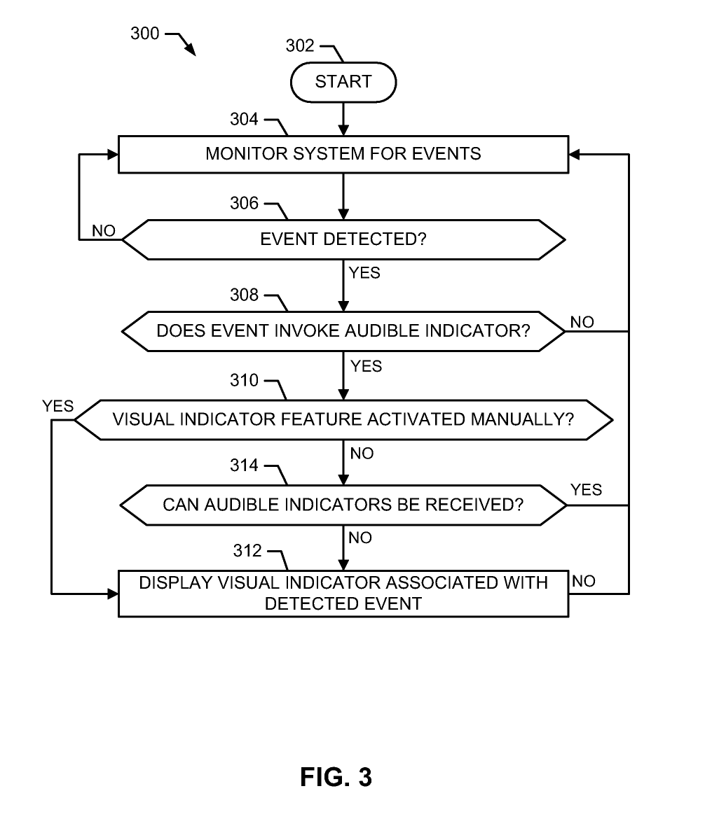

As described below in connection with FIG. 3, the example event controller 240 may determine whether a detected event causes the media presentation system to generate an alert, warning, or other indicator (e.g., audio to be presented to the user via a speaker system) to inform the user of a condition (e.g., that an event is restricted or involves a request for unavailable features, options, information, etc.). Additionally or alternatively, the event controller 240 may determine that a detected event causes the media presentation system to generate, for example, an audio effect indicating a successful request, advancement through the user interface, completion of a download, activation of a feature, etc. When the event controller 240 determines that such an indication (e.g., an audible ‘beep’ or ‘bonk’) is invoked but may not be received by the user, the event controller 240 may also cause the media presentation system or user interface to generate and display a corresponding visual indicator (e.g., an image or text-based graphic corresponding to the audio indicator). Thus, the event controller 240 and the associated methods described herein may alleviate problems experienced by the hearing-impaired and/or users (e.g., people in a crowded public place) who otherwise are unable to hear such audio indications.

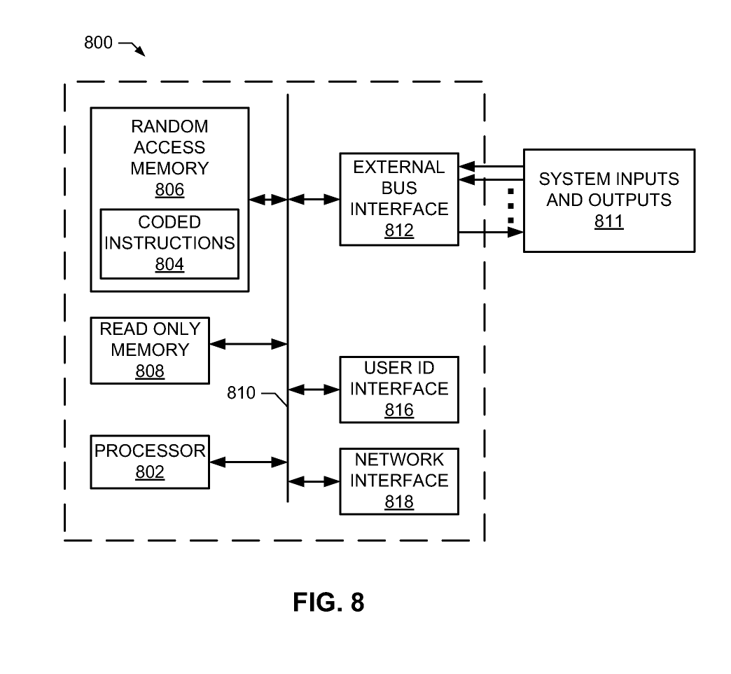

Although the following discloses example processes through the use of flow diagrams having blocks, it should be noted that these processes may be implemented in any suitable manner. For example, the processes may be implemented using, among other components, software, or firmware executed on hardware. However, this is merely one example and it is contemplated that any form of logic may be used to implement the systems or subsystems disclosed herein. Logic may include, for example, implementations that are made exclusively in dedicated hardware (e.g., circuits, transistors, logic gates, hard-coded processors, programmable array logic (PAL), application-specific integrated circuits (ASICs), etc.), exclusively in software, exclusively in firmware, or some combination of hardware, firmware, and/or software. For example, instructions representing some or all of the blocks shown in the flow diagrams may be stored in one or more memories or other machine readable media, such as hard drives or the like (e.g., the memories 806 and/or 808 of FIG. 8). Such instructions, which may be executed by one or more processors (e.g., the processor 802 of FIG. 8), may be hard coded or may be alterable. Additionally, some portions of the processes may be carried out manually. Furthermore, while each of the processes described herein is shown in a particular order, those having ordinary skill in the art will readily recognize that such an ordering is merely one example and numerous other orders exist. Accordingly, while the following describes example processes, persons of ordinary skill in the art will readily appreciate that the examples are not the only way to implement such processes. Further, while certain buttons (e.g., ‘Enter’) are described below, it will be appreciated that the titles or names of such buttons are meant for illustrative purposes and that other suitable names, symbols, or numbers may be assigned to similar buttons to represent the following instructions, features, options, and/or instructions similar thereto.

FIG. 3 is a flowchart representing an example process 300 that may be implemented via, for example, the IRD 130 of FIGS. 1 and 2. Specifically, the example process 300 detects and/or responds to events associated with the operation of a media presentation system (e.g., the system 100 of FIG. 1) and the features (e.g., a user interface or program guide) or options thereof. For illustrative purposes, the process 300 is described in conjunction with example screenshots 400, 500, 600, and 700, each including a visual indicator 402, 502, 602, and 702, respectively. However, the example process 300, the visual indicators 402, 502, 602, and 702, and the associated features and methods described herein are non-limiting examples meant for illustrative purposes.

The process 300 starts with an activation of a media presentation system (e.g., the system 100 of FIGS. 1 and 2) or a feature thereof (block 302). The activation may occur upon the powering up of a set-top (e.g., the IRD 130 of FIGS. 1 and 2) or a display device (e.g., a television set, a computer, or other media presentation devices), or upon the activation of a user interface or portion thereof from a menu or remote control. Additionally or alternatively, the process 300 may begin upon an activation of a program guide or as soon as content is presented to the user.

A module or device (e.g., the event controller 240 of FIG. 2) may monitor the operation of the media presentation system (e.g., via a user interface or any other type of interaction with the system) for events (block 304). For example, the engagement of a button (e.g., a ‘Select’ button on a remote control) or option from an on-screen menu may set a bit in the module or device to signify that an event has occurred. An example event includes an attempt (e.g., a command generated by the engagement of a button on a remote control) to navigate through a menu or list having available programming, options, and/or features. The user interface may include one or more such menus or lists having on-screen graphics (e.g., arrows) corresponding with buttons on a remote control (e.g., page up/down buttons) or other interface panel (e.g., buttons on a set-top box) used to navigate through the available channels or features. Additionally or alternatively, the menus or lists may be explored by entering a channel number (e.g., via a keypad on a remote control), causing a cursor to jump to the entered channel number.

The engagement of these options may cause an action in the user interface (e.g., a scrolling or jumping) and a corresponding notification (e.g., an audio or visual effect) when the requested action is available or can be accommodated. In other examples, where the action requested by the event cannot be accommodated and/or is unavailable in the current state or condition of the media presentation system, the user may be notified (audibly and/or visually) of the unavailability of the requested option or the inability of the system to perform the requested action. In other words, depending on a condition (e.g., a current position of a cursor in a menu, a mode of the user interface, recorded content being played back, the presence of new messages in a mailbox, transitioning of states, experiencing a system error, etc.) of the media presentation system or associated user interface, the action requested by the event may or may not be performed. Further, the audience or user may be notified (e.g., via audible and/or visual indicators) as to whether the requested action may be performed.

In the example process 300 of FIG. 3, when an event is detected (e.g., by the event controller 240) (block 306), the process 300 determines whether the event is one that invokes an indicator (e.g., an audible ‘bonk’ or ‘beep’) (block 308). As described above, such events may be associated with one or more elements of the user interface. For example, a ‘bonk’ may be generated upon the engagement of a button that has no assigned operation given the state of the user interface (e.g., pressing an ‘Info’ button when the full information screen is currently being displayed). A ‘bonk’ may be generated when the user attempts to access options (e.g., an on-demand service) or to tune to channels that require additional subscriptions that the user does not have. A ‘beep’ may be generated when a download has been completed or a new message has been received in an electronic mailbox. Additional or alternative examples may also trigger similar sounds or audio effects. Further, different sounds may be generated depending on what type of event triggered the indication. Moreover, such sounds and the assignment of which sound corresponds to which event may be default settings or may be customizable by the user. As described below, the visual indicators that correspond to the sounds and the assignments thereof may also be customizable by the user. For example, the user may create or upload a graphic to be displayed as a visual indicator or may modify the aspects (e.g., color, shape, size, duration of display, etc.) of selectable visual indicators (e.g., visual indicators in a library of graphics created by a content delivery system provider to be selected by the user).

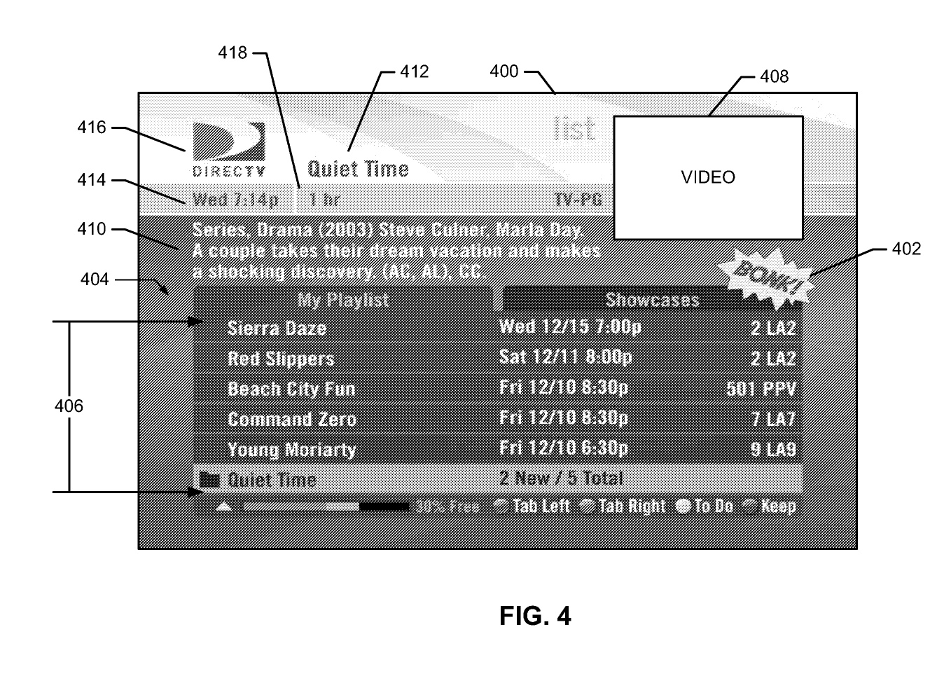

If the event does not invoke an indicator, the system may perform the action requested by the event and the process 300 may continue to monitor the system for events (block 304). Alternatively, if the detected event does invoke an indicator, the process 300 may then determine whether a visual indicator should be displayed. The visualization feature may be activated manually by the user (e.g., via a setting in the user interface) (block 310). For example, the visualization feature may be manually activated when one or more users are hearing-impaired and, thus, unable to hear (i.e., audibly receive) an audible indication of a condition of the media presentation system (e.g., a switching of modes from live broadcast viewing to an on-demand mode). Such a hearing-impaired user may manually set the visualization feature, causing the visualization feature to remain active despite any powering off of the media presentation system or a component thereof. In some examples, the visualization feature may be activated in a loud place (e.g., a restaurant or bar) that may include one or more displays (e.g., television sets). In some examples, the user may manually active the visualization feature due to a preference of the visual indicators, regardless of any inability to hear an audio indicator. Where the process 300 determines that such a manual setting is active, one or more visual indicators (e.g., the visual indicators 402, 502, 602, and 702 of FIGS. 4-7) associated with the detected event are displayed (block 312).

The process 300 may also determine whether an audible indicator can be audibly received by one or more users (block 314). If the audio indicators cannot be audibly received, the associated visual indicators are displayed (block 312). For examples, the system may be muted for any variety or reasons and thus unable to generate an audible effect (e.g., a ‘bonk’ sound to indicate that a hard disk is full). In some examples, a closed-captioning function is activated when the mute function is active or may be activated independent of the mute function. In some examples, the process 300 may determine whether the volume level is set below a threshold value (e.g., a preset value or a setting that may be adjusted by a user), thereby restricting the ability of the user to audibly receive an audio indicator. Interacting with a system in any of these situations (or any other situation in which the user is unable to receive an indication produced by the system) may prove difficult without any useful indicators to inform the user of, for example, an unavailability or inability to perform a requested action. These and other problems may be alleviated by the visual indicators described herein.

FIGS. 4-7 show example screenshots 400, 500, 600, and 700 including example visual indicators 402, 502, 602, and 702. As described above, the example screenshots 400, 500, 600, and 700 and the visual indicators 402, 502, 602, and 702 are non-limiting examples and are meant for illustrative purposes. The example screenshots 400, 500, 600, and 700 show an example portion 404 of an example user interface. Specifically, the example portion 404 includes a list 406 of recorded content or programs. The list 406 may include programs downloaded from an on-demand or pay-per-view service or programs recorded by a Digital Video Recorder (DVR). The example portion 404 of the user interface may also include a video section 408 to display a currently tuned channel, an information section 410, a title section 412, a current date and time 414, a source indicator 416 (e.g., a logo), a duration section 418, and additional or alternative features to assist the user utilization the media presentation system.

The example visual indicator 402 of FIG. 4 includes ajagged shape to distinguish it from the other elements of the user interface. Further, the example visual indicator 402 includes embedded text (e.g., the word ‘BONK’) corresponding to an audible effect that may, for example, comprise a notification or warning to the user. In some examples, the visual indicator 402 may be displayed when a requested action is unavailable, when a task (e.g., a download) has been completed, during a change of operational modes, etc. Further, the characteristics or aspects of the visual indicator 402 may be customizable by the user.

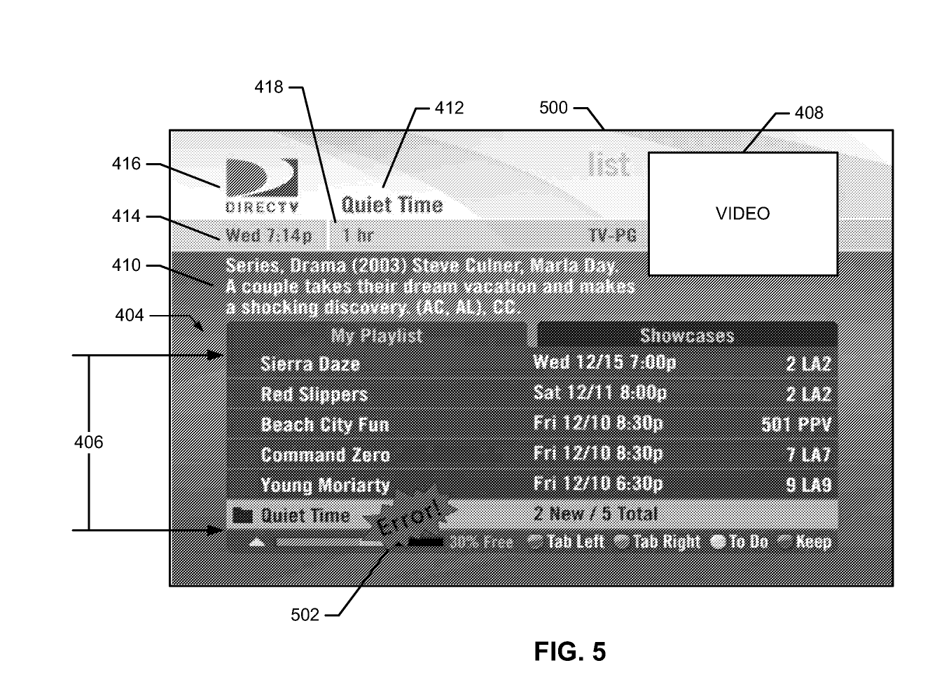

Other visual indicators may include alternative texts or graphics (e.g., various colors, words, shapes, sizes, etc.) depending on, for example, the basis on which the visual indicator is displayed. For example, while the visual indicator 402 may be displayed when, for example, a menu cannot scroll as requested, the example visual indicator 502 of FIG. 5 may be displayed to indicate that, for example, a memory is full or that difficulty was encountered during a download or other date transfer. The visual indicator 502 of includes the word ‘ERROR’ and such a textual difference (i.e., from the visual indicator 402 of FIG. 4) may be specific to the type of condition that causes the system to inform the user or may be independent of the same. For example, either the visual indicator 402 of FIG. 4 or the visual indicator 502 of FIG. 5 may be displayed when an unavailable action is requested. In other examples, each embedded text (e.g., ‘ERROR’ or ‘BONK’) may be assigned to specific conditions of the system.

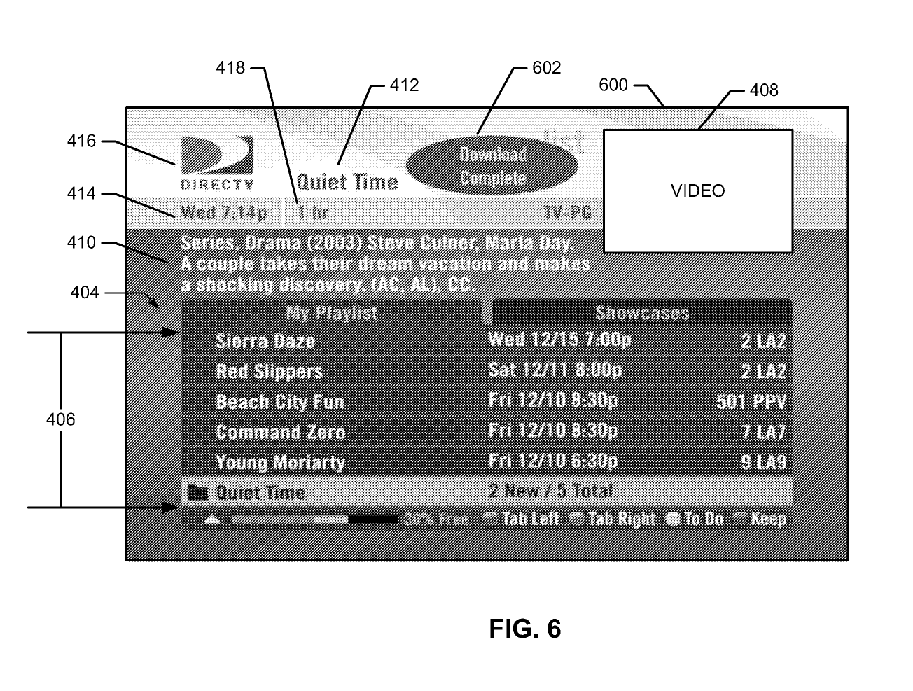

The example visual indicator 602 of FIG. 6 illustrates another example shape and embedded text. Specifically, the visual indicator 602 includes a message (e.g., ‘Download Complete’) to indicate that a completion of a task (e.g., a transmission and/or storage of on-demand content). Further, the screenshot 600 illustrates that the visual indicators described herein may be positioned in any variety of locations. For example, the visual indicators may be positioned proximate to an area or section of the user interface associated with the event that invoked the audible and/or visual indication. The visual indicators may be positioned over a full-screen display of programming or recorded content, over a menu of the user interface, within the video section 408, in a fixed location of the display, etc. Further, the positioning of the visual indicators may be determined by a user setting that may be changed via the user interface (e.g., a menu dedicated to the operation of the visualization feature including placement and/or activation options).

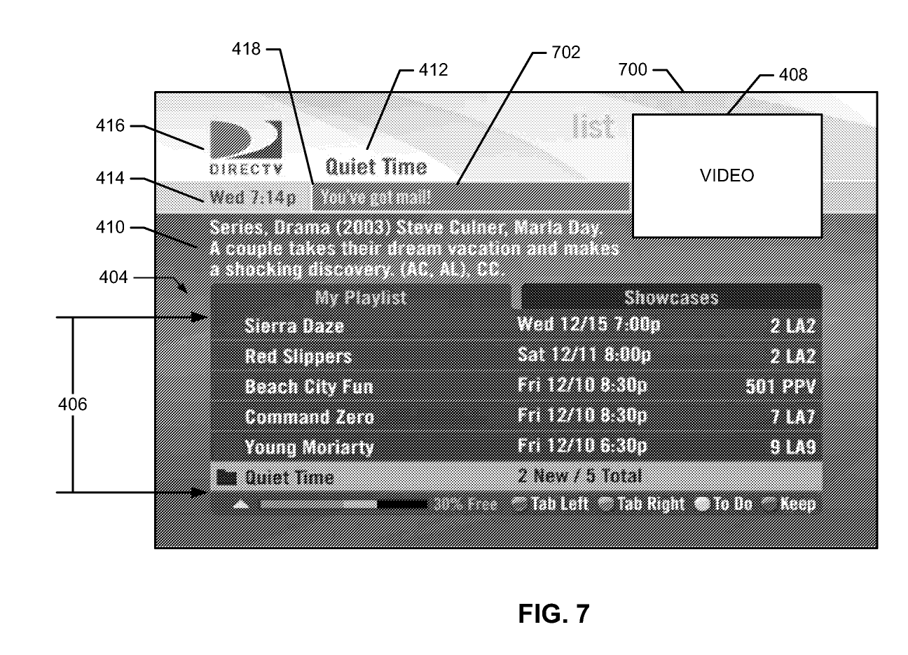

In some examples, a visual indicator may be assigned a shape and/or location similar to an existing element of the user interface. For example, as shown in FIG. 7, an example visual indicator 702 may be positioned in and assigned a similar shape of the duration section 418. Specifically, the visual indicator 702 includes embedded text (e.g., ‘You've got mail!’) indicating that the system has one or more new messages or messages that have not been reviewed. In some examples, the visual indicator 702 may be assigned a color to distinguish it from the surrounding elements of the user interface.

Further, the visual indicators may include such varying characteristics (e.g., color, shape, etc.) based on the condition of the media presentation system and/or user interface that causes the example visual indicators to be displayed. For example, the visual indicators may be yellow when the user interface is changing screens (e.g., transitioning from a program guide to an information screen), red when a requested action is unavailable (e.g., a menu cannot be scrolled down any further), green when an action is taken successfully, etc. Additionally and/or alternatively, the characteristics of the visual indicators may depend on the currently displayed content (e.g., a currently tuned channel or playback of recorded content). For example, the provider of the media presentation system may assign different characteristics to the visual indicators based on the type of content (e.g., comedy, drama, sports, etc.) or channel being viewed by the user. In some examples, such characteristics may include a graphic associated with a genre (e.g., a football graphic for sports) or a content provider (e.g., a logo of a broadcast channel). Similarly, the contents of the embedded text may depend on the condition of the media presentation system and/or the user interface.

Additionally and/or alternatively, the visual indicators may be presented for variable, static, repeating, or dynamic durations. The duration of display may depend on, for example, a repetition of a request, a default setting, or the condition of the system and/or the user interface. Further, similar to the other aspects of the visual indicators described herein, the duration of display may be customizable via a setting in the user interface.

The methods and apparatus described herein may be designed by, for example, a content delivery system (DIRECTV®) programmer and/or a content provider (e.g., a broadcasting company). Where the visual indicators (e.g., graphics containing text corresponding to an audio indicator) are designed and/or added to elements or portions of a program guide by a content provider (e.g., the National Broadcasting Company), the content delivery system programmer may make adjustments to tailor the visual indicators to comply with system parameters (e.g., size or shape of a graphic).

FIG. 8 is a schematic diagram of an example manner of implementing an example processor unit 800 to execute the example methods and apparatus described herein. The example processor unit 800 of FIG. 8 includes a general purpose programmable processor 802. The example processor 802 may execute, among other things, machine accessible instructions 804 (e.g., instructions present within a random access memory (RAM) 806 as illustrated and/or within a read only memory (ROM) 808) to perform the example processes described herein. The example processor 802 may be any type of processing unit, such as a microprocessor.

The processor 802 may be coupled to an interface, such as a bus 810 to which other components may be interfaced. The example RAM 806 may be implemented by dynamic random access memory (DRAM), Synchronous DRAM (SDRAM), and/or any other type of RAM device, and the example ROM 808 may be implemented by flash memory and/or any other desired type of memory device. Access to the example memories 808 and 806 may be controlled by a memory controller (not shown) in a conventional manner.

To send and/or receive system inputs and/or outputs, the example processor unit 800 includes any variety of conventional interface circuitry such as, for example, an external bus interface 812. For example, the external bus interface 812 may provide one input signal path (e.g., a semiconductor package pin) for each system input. Additionally or alternatively, the external bus interface 812 may implement any variety of time multiplexed interface to receive output signals via fewer input signals.

To allow the example processor unit 800 to interact with a remote server, the example processor unit 800 may include any variety of network interfaces 818 such as, for example, an Ethernet card, a wireless network card, a modem, or any other network interface suitable to connect the processor unit 800 to a network. The network to which the processor unit 800 is connected may be, for example, a local area network (LAN), a wide area network (WAN), the Internet, or any other network. For example, the network could be a home network, an intranet located in a place of business, a closed network linking various locations of a business, or the Internet.

Although an example processor unit 800 has been illustrated in FIG. 8, processor units may be implemented using any of a variety of other and/or additional devices, components, circuits, modules, etc. Further, the devices, components, circuits, modules, elements, etc. illustrated in FIG. 8 may be combined, re-arranged, eliminated and/or implemented in any of a variety of ways.

The apparatus and methods described above are non-limiting examples. Although the example apparatus and methods described herein include, among other components, software executed on hardware, such apparatus and methods are merely illustrative and should not be considered as limiting. For example, it is contemplated that any or all of the disclosed hardware and software components could be embodied exclusively in dedicated hardware, exclusively in software, exclusively in firmware or in some combination of hardware, firmware, and/or software.

Further, although certain example methods and apparatus have been described herein, the scope of coverage of this patent is not limited thereto. On the contrary, this patent covers all methods and apparatus fairly falling within the scope of the appended claims either literally or under the doctrine of equivalents.

What is claimed is:

1. A method for use in a media presentation system comprising:
monitoring the media presentation system for one or more events;
detecting an event that causes the media presentation system to generate a sound to inform a user of a condition;
determining whether the user is able to audibly receive the sound; and
displaying a visual indicator corresponding to the condition in response to a determination that the user is unable to audibly receive the sound.

2. A method as defined in claim 1, further comprising determining a user-selected location to present the visual indicator.

3. A method as defined in claim 1, further comprising determining which section of a user interface is associated with the event and displaying the visual indicator proximate to the section.

4. A method as defined in claim 1, wherein determining whether the user is able to audibly receive the sound comprises detecting an active mute function.

5. A method as defined in claim 1, wherein determining whether the user is able to audibly receive the sound comprises determining whether a volume level is below a threshold value.

6. A method as defined in claim 1, wherein determining whether the user is able to audibly receive the sound comprises detecting an active closed-captioning function.

7. A method as defined in claim 1 wherein determining whether the user is able to audibly receive the sound comprises detecting if the user is hearing-impaired.

8. A method as defined in claim 1, further comprising displaying the visual indicator in response to a manual activation of a visual indicator setting.

9. A method as defined in claim 1, the condition comprising at least one of a new message, an invalid input, a system error, a menu transition, or a cursor movement.

10. An apparatus comprising:
a media presentation system in which one or more events may occur;
an event controller to detect an event that causes the media presentation system to generate a sound to inform a user of a condition and to determine if the user is able to audibly receive the sound; and
a visual indicator corresponding to the condition to be displayed in response to a determination that the user is unable to audibly receive the sound.

11. An apparatus as defined in claim 10, the event comprising a request for an unavailable action associated with the media presentation system.

12. An apparatus as defined in claim 10, the visual indicator including a graphic having embedded text to represent an audio effect.

13. An apparatus as defined in claim 10, the visual indicator having a substantially similar size and shape of an element of a user interface over which the visual indicator is displayed.

14. An apparatus as defined in claim 10, wherein the visual indicator is designed by a content delivery system provider.

15. An apparatus as defined in claim 10, wherein the visual indicator is designed by a content provider.

16. An apparatus as defined in claim 10, the visual indicator comprising a graphic associated with content currently being viewed.

17. An apparatus as defined in claim 10, the visual indicator comprising a graphic associated with a currently tuned channel.

18. A media presentation system comprising:
a transmission system capable of generating and transmitting streams of audiovisual data;
a receiver capable of receiving audiovisual data and generating video and audio output signals;
a display device, wherein the receiver, the transmission system, and the display device are in communication;
a user interface in which one or more events may occur;
an event controller to detect an event that causes the media presentation system to generate a sound to inform a user of a condition and to determine if the user is able to audibly receive the sound; and
a visual indicator corresponding to the condition to be displayed in response to a determination that the user is unable to audibly receive the sound.

19. A media presentation system as defined in claim 18, wherein the user defines which events trigger the display of the visual indicator.

20. A media presentation system as defined in claim 18, wherein the visual indicator is customizable by the user.
